(19) United States
(12) Patent Application Publication
(10) Pub. No.: US 2003/0087618 A1
(43) Pub. Date: May 8, 2003

(54) Digital FM stereo decoder and method of operation

(76) Inventors: Junsong Li, Austin, TX (US); Kai Tan, ChengDu, SiChuan (CN)

Correspondence Address: MOTOROLA INC, AUSTIN INTELLECTUAL PROPERTY, LAW SECTION, 7700 WEST PARMER LANE MD: TX32/PL02, AUSTIN, TX, 78729

(21) Appl. No.: 10/007,763

(22) Filed: Nov. 8, 2001

(51) Int. Cl. H04B 1/16; H04B 1/06; H04B 7/00

(52) U.S. Cl. 455/214; 455/260

(57) ABSTRACT

A cost effective digital stereo decoder (216) for Digitized Intermediate Frequency (DIF) FM radio receiver (100). After FM demodulation (212), a multiplex signal (MPX) at a high sampling rate is mixed with free-running local quadrature mixers (308, 320) to shift the (L−R) stereo signal to baseband. The MPX signal is also mixed with a free-running locally generated carrier signal to translate an embedded 19 KHz pilot tone signal to 1 KHz. The pilot tone signal is decimated to a low sampling rate to permit a phase-lock loop (PLL) to be applied to the lower rate signal to estimate the phase of the pilot signal. An FM blender controller is used to attenuate high frequency noise and improve audio quality. The receiver may be implemented in software and be customer configurable to have various operating characteristics.

### CROSS REFERENCE TO RELATED APPLICATIONS

This application is related to copending U.S. application Ser. No. 09/916,685 entitled “Receiver and Method Therefor”, to copending U.S. application Ser. No. 09/916,915 also entitled “Receiver and Method Therefor”, and to U.S. application Ser. No. 09/818,337 entitled “Radio Receiver Having A Dynamic Bandwidth Filter And Method Therefor”, all of which are assigned to the current assignee hereof.

### FIELD OF THE INVENTION

This invention relates generally to FM receivers, and more specifically, to stereo FM receivers.

### BACKGROUND OF THE INVENTION

Stereo FM receivers are commonly used in many consumer products. An analog signal is received and is digitized in an intermediate frequency (IF) stage. After being digitized, the signal is demodulated in an FM demodulator to obtain a frequency multiplexed stereo signal. The frequency multiplexed (MPX) stereo signal comprises at least a summation signal of left and right channels (L+R) at baseband, a pilot signal at 19 kHz, a difference signal of left and right channels (L−R) centered about 38 kHz, and a radio data signal (RDS) at 57 KHz. The specific frequencies are determined by a commonly adopted standard. The (L−R) audio component is then extracted from the multiplexed stereo signal and combined with the (L+R) audio component to obtain a distinct L channel and a distinct R channel to provide the stereo output.

To perform stereo decoding, to extract the (L−R) signal, you must recover the 19 KHz pilot signal. The recovered pilot signal is often frequency doubled to 38 KHz. This signal is used to mix the (L−R) signal down to baseband. In recovering the 19 KHz signal, phase information must also be accurately recovered. Lack of accurate phase recovery results in a degraded audio quality. The lack of accurate phase recovery is particular noticeable for weaker input signals.

Due to the presence of a significant noise component in the composite MPX signal, a process that utilizes a stereo blender circuit is required to remove a significant portion of the noise. Traditional blender circuits attenuate the (L−R) frequency components to reduce the effects of noise. Afterwards, a high-cut circuit is used that removes the high frequency components from the (L+R) signal. However, when the (L−R) signal is attenuated, signal information is removed in addition to the noise.

### BRIEF DESCRIPTION OF THE DRAWINGS

The present invention is illustrated by way of example and is not limited by the accompanying figures, in which like references indicate similar elements.

FIG. 1 illustrates in block diagram form a radio receiver for using the stereo decoder of the present invention;

FIG. 2 illustrates in block diagram form a portion of a baseband unit of FIG. 1;

FIG. 3 illustrates in block diagram form a stereo decoder portion of a signal processing unit of FIG. 2;

FIG. 4 illustrates in block diagram form a stereo blender of FIG. 3; and

FIG. 5 illustrates in block diagram form a phase lock loop of FIG. 4.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION OF THE DRAWINGS

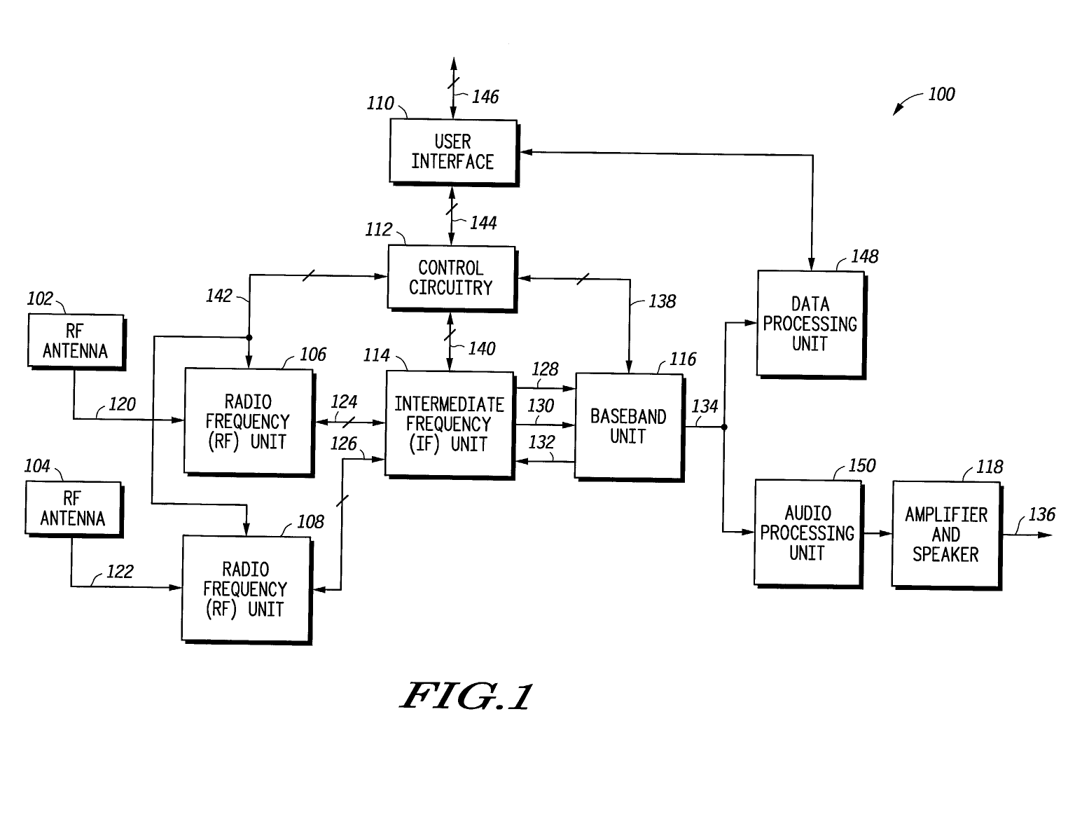

FIG. 1 illustrates a radio receiver in accordance with one embodiment of the present invention. Radio receiver 100 includes user interface 110 bi-directionally coupled via conductors 144 to control circuitry 112. Control circuitry 112 is bi-directionally coupled to radio frequency (RF) units 106 and 108 via conductors 142, to intermediate frequency (IF) unit 114 via conductors 140, and baseband unit 116 via conductors 138. RF Unit 106 is coupled to RF antenna 102 via conductor 120 and is bi-directionally coupled to IF unit 114 via conductors 124. RF Unit 108 is coupled to RF antenna 104 via conductor 122 and is bi-directionally coupled to IF unit 114 via conductors 126. IF unit 114 is coupled to base band unit 116 via conductors 128, 130 and 132. Base band unit 116 is coupled to audio processing unit 150 and data processing unit 148 via conductor 134. Audio processing unit 150 is coupled to amplifier and speaker 118 that provides output signals via conductor 136. Data processing unit 148 is bidirectionally coupled to user interface 110. Also, users may provide and receive information to and from user interface 110 via conductors 146.

In operation, RF antennas 102 and 104 capture radio signals and provide them to RF Units 106 and 108, respectively. RF Units 106 and 108 translate the received radio signals to a common intermediate frequency range as dictated by the design of the radio receiver. That is, RF Units 106 and 108 may translate the frequency of the received radio signals to a lower frequency or to a higher frequency depending on the requirements of IF Unit 114. IF unit 114 receives the RF signals via conductors 124 and 126 and digitizes them through the use of an analog to digital converter. IF unit 114 also performs digital mixing to produce in-phase and quadrature digitized signals that are output via conductors 128 and 130 to base band unit 116. In alternate embodiments, IF unit 114 is optional. That is, RF units 106 and 108 may translate the received radio signals from antennas 102 and 104 directly to base band and may include an analog to digital converter to provide the digitized base band signals directly to base band unit 116. (Also note that RF units 106 and 108 and IF unit 114, if used, may be referred to as a “lower frequency unit” or “higher frequency unit” depending on whether the received radio signals need to be translated to a lower or higher frequency, respectively.)

Base band unit 116 receives the digitized radio signals from intermediate frequency unit 114 or, if no IF unit exists, directly from RF units 106 and 108. Base band unit 116 performs signal conditioning, demodulation, and decoding in order to produce audio and data information via conductor 134. The processing performed by base band unit 116 will be further described in reference to later figures. Audio information via conductor 134 may be provided to audio processing unit 150 which may be coupled to amplifier and speaker 118 to produce an audio output from radio receiver 100 via conductor 136. For example, this may be music played from radio speakers. Alternatively, base band unit 116 may output data information via conductor 134 to data processing unit 148 for further processing. The output of data processing unit 148 may be coupled to user interface 110 to allow user interaction with the output of radio receiver 100. For example, user interface 110 may represent a radio dial, a touch screen, monitor and keyboard, keypad, or any other suitable input/output device. The data information may represent text, graphics, or any other information transmitted in digital form.

In alternate embodiments, radio receiver 100 may be used for different formats of data such as AM, FM, GPS, digital T.V., T.V., digital/audio broadcast, audio broadcast, digital/video broadcast, or the like. Furthermore, radio receiver 100 may be designed to receive frequencies other than radio frequencies. Antennas 102 and 104 may therefore be referred to as sensors capable of sensing a variety of data formats. Furthermore, each of the sensors or antennas in the system may receive different formats of data so that, for example, one sensor may receive radio signals while other sensors may receive different types of data as listed above. Also, radio receiver 100 of FIG. 1 illustrates two sensors or antennas (e.g. antennas 102 and 104); however, alternate embodiments may use any number of sensors for capturing signals or information.

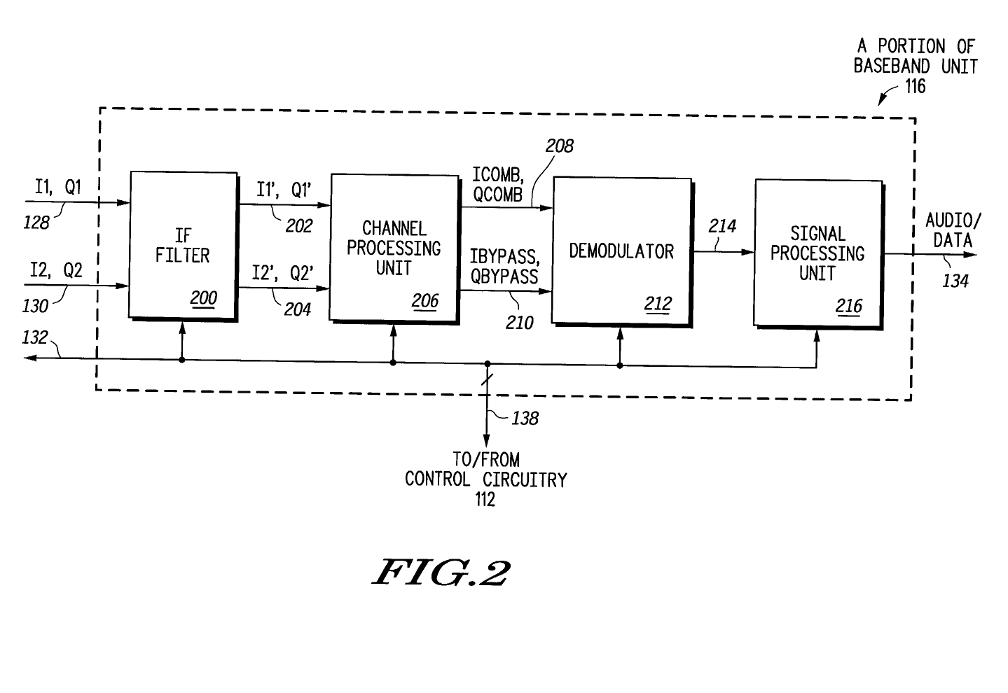

FIG. 2 illustrates one embodiment of a portion of baseband unit 116. IF filter 200 receives in-phase and quadrature signal pairs I1, Q1 and I2, Q2 via conductors 128 and 130, respectively, where I1, Q1 corresponds to the signal received via sensor or antenna 102 and I2, Q2 corresponds to the signal received via sensor or antenna 104. I1 and I2 represent the digitized in-phase signals while Q1 and Q2 represent the digitized quadrature signals (e.g. signals that are 90 degrees out of phase as compared to the in-phase signals). (Note also that each signal such as I1, Q1 and I2, Q2 can be represented as a complex number where I1 and I2 represent the real portions and Q1 and Q2 represent the imaginary portions, as will be discussed further below.) IF filter 200 is coupled to channel processing unit 206 via conductors 202 and 204. Channel processing unit 206 is coupled to demodulator 212 via conductors 208 and 210, and demodulator 212 is coupled to signal processing unit 216 via conductor 214. Signal processing unit 216 provides audio/data information via conductor 134. IF filter 200, channel processing unit 206, demodulator 212, and signal processing unit 216 are coupled to control circuitry 112 via conductors 138. Conductors 138 may be referred to as a control bus including a variety of conductors for transferring different signals to and from units 200, 206, 212 and 216. Conductor 132, for example, may include a subset of conductors 138 or may be the full bus 138 that is provided back to intermediate frequency unit 114. Therefore, control signals received via conductor 138 may be transmitted to IF frequency unit 114 via conductor 132. Likewise, these control signals or subsets of these signals may be transmitted back to the RF units 106 and 108 via conductors 124 and 126. Alternatively, control signals may be sent directly from control circuitry 112 to radio frequency units 106 and 108 via conductor 142.

In operation, IF filter 200 removes unwanted signals and noise from the desired frequency range of incoming signals I1, Q1, and I2, Q2. IF filter 200 also suppresses adjacent channels in order to produce filtered in-phase and quadrature signal pairs I1′, Q2′, and I2′, Q2′, where I1′, Q1′ corresponds to I1, Q1 and I2′, Q2′ corresponds to I2, Q2. Channel processing unit 206 receives I1′, Q1′ and I2′, Q2′ and combines these to produce a single combination signal Icomb, Qcomb. Alternatively, channel processing unit 206 may also provide one of its incoming signals such as I1′, Q1′ or I2′, Q2′ directly to demodulator 212 via conductor 210 as Ibypass, Qbypass. Therefore, channel processing unit 206 provides the option of combining its incoming digitized signals or bypassing them directly to further processing units such as demodulator 212. Channel processing unit 206 may also provide both a combined signal such as Icomb, Qcomb and a bypass signal such as Ibypass, Qbypass. Channel processing unit 206 and Ibypass, Qbypass also provide the ability to receive different types of signal formats such that one signal, such as I1′, Q1′, may be processed by channel processing unit 206 and output via conductor 208 while a second signal, such as I2′, Q2′, may be a different signal format that is directly bypassed to demodulator 212. (Alternatively, I1′, Q1′ may be output via conductor 208 without being processed by channel processing unit 206). This allows channel processing unit 206 to provide either a single combination signal or various different signals for further processing. For example, one antenna may provide signals from one radio station while a second antenna may provide signals from a second radio station or of a different data format all together. Channel processing unit 206 may also perform noise canceling on the received signals.

Also note that the embodiment illustrated in FIG. 2 illustrates only two signals received by IF filter 200 and channel processing unit 206. However, as was discussed in reference to FIG. 1, radio receiver 100 may include any number of antennas such as 102 and 104. In this embodiment, each antenna would provide its own in-phase and quadrature signal pair such as I1, Q1 to IF filter 200. In this embodiment, IF filter 200 may provide a plurality of filtered in-phase and quadrature signal pairs corresponding to each of the antennas. In this manner, channel processing unit 206 may output a single combination signal or multiple subcombinations of signals, as appropriate. Also, channel processing unit 206 may provide multiple bypass signals so that more than one incoming signal may be directly bypassed to further processing units such as demodulator 212.

Demodulator 212 receives signals Icomb, Qcomb and Ibypass, Qbypass from channel processing unit 206 and provides demodulated signals to signal processing unit 216 via conductor 214. Also, if demodulator 212 receives signals Ibypass, Qbypass, demodulator 212 may provide a demodulated Ibypass, Qbypass, also via conductor 214 to signal processing unit 216. However, as discussed above, Ibypass, Qbypass is optional. For example, in one embodiment, demodulator 212 may be an FM demodulator providing multiplex (MPX) signals corresponding to each of its incoming signals (e.g. Icomb, Qcomb and Ibypass, Qbypass). In alternate embodiments, demodulator 212 may be an AM demodulator or a demodulator specific to any other signal format as required by the system (e.g. radio receiver 100) and incoming signals I1, Q1 and I2, Q2. Signal processing unit 216 may perform further processing on the signals received via conductor 214 and outputs audio/data information via conductor 134. Audio/data information may include just audio information, just data information or a combination of both audio and data information. This data may then be output to various different systems such as data processing systems or audio processing systems, as illustrated in FIG. 1. For example, in an FM receiver, demodulator 212 outputs an MPX signal to signal processing unit 216 as discussed above. In this embodiment, signal processing unit 216 receives the MPX signal and performs stereo decoding in order to provide the proper signals to each speaker. For example, the MPX signal may be decoded utilizing a pilot tone to provide left and right speaker signals in a stereo system. Also, signal processing unit 216 may demodulate other sub-carrier signals (e.g. RDS or DARC) to provide further information to subsequent processing units.

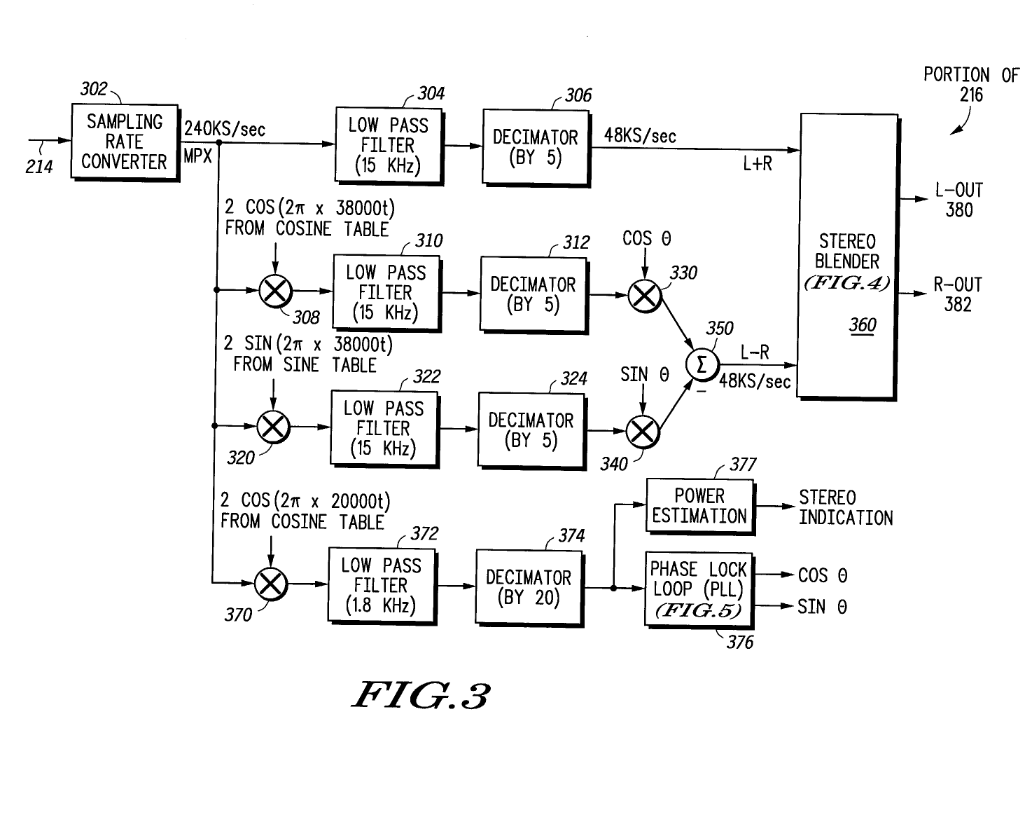

Illustrated in FIG. 3 is a digital FM stereo decoder portion of signal processing unit 216 of FIG. 2. Signal 214 of FIG. 2 functions as an input signal and is coupled to an input of a sampling rate converter 302. An output of sampling rate converter 302 provides a frequency multiplexed signal labeled “MPX” having a sampling rate of 240 K samples per second. The MPX signal is connected to an input of a low pass filter 304. Low pass filter has a cut off frequency of 15 KHz and filters or blocks all frequencies above 15 KHz. An output of low pass filter 304 is connected to an input of a decimator 306. Decimator 306 performs decimation by a factor of five. An output of decimator 306 provides a Left plus Right (L+R) stereo signal at a sampling rate of 48 K samples per second. An output of sampling rate converter 302 is also connected to a first input of a multiplier 308. A second input of multiplier 308 receives a signal from a cosine table (not shown) having a value of 2 cos (2π×38000t) where t is time. An output of multiplier 308 is connected to an input of a low pass filter 310 having a cut off frequency of 15 KHz. An output of low pass filter 310 is connected to an input of a decimator 312 that decimates by a factor of five. An output of sampling rate converter 302 is also connected to a first input of a multiplier 320. A second input of multiplier 320 receives a signal from a sine table (not shown) having a value of 2 sin (2π×38000t) where t is time. An output of multiplier 320 is connected to an input of a low pass filter 322 that has a cut off frequency of 15 KHz. An output of low pass filter 322 is connected to an input of a decimator 324. An output of decimator 312 is connected to a first input of a multiplier 330. A second input of multiplier 330 receives a signal that is a cosine function equal to Cosθ. An output of decimator 324 is connected to a first input of a multiplier 340. A second input of multiplier 340 receives a signal that is a sine function equal to Sinθ. An output of multiplier 330 is connected to a first input of an adder 350. An output of multiplier 330 is connected to a second input of adder 350. An output of adder 350 provides a first data component of a stereo signal that is equal to (L−R) at a sampling rate of 48K samples per second. The (L+R) signal is a second data component and is connected to a first input of a stereo blender 360 and the (L−R) signal is connected to a second input of stereo blender 360. The (L−R) signal, the first data component, is a difference between a left channel and a right channel, and the (L+R) signal, the second data component, is a summation of the left channel and the right channel. Stereo blender 360 has a first output signal that is the right stereo channel (R-Out) 382 of the FM stereo signal and has a second output signal that is the left stereo channel (L-Out) 380. The R-Out signal is a right channel output signal and the L-Out signal is a left channel output signal. An output of sampling rate converter 302 is also connected to a first input of a multiplier 370. A second input of multiplier 370 is connected to a signal having a predetermined cosine value equal to 2Cos (2π×20000t) where t is time. This signal is a free running carrier signal meaning that the value of the signal is not influenced by an external source. An output of multiplier 370 is an intermediate signal that is connected to an input of a low pass filter 372. Low pass filter 372 has a cut off frequency of 1.8 KHz. An output of low pass filter 372 is connected to an input of a decimator 374. Decimator 374 has a decimation factor of twenty. An output of decimator 374 is connected to an input of a phase lock loop (PLL) 376. Phase lock loop has a first output for providing a signal labeled Cosθ and a second output for providing a signal labeled Sinθ. An output of decimator 374 is connected to a first input of a power estimation circuit 377. An output of power estimation circuit 377 provides a Stereo Indication output signal.

In operation, sampling rate converter 302 receives an FM demodulated signal at its input. Sampling rate converter 302 reduces the sampling rate of the FM demodulated signal from a rate such as 960K samples per second to a rate of 240K samples per second. The output of sampling rate converter 302 is a multiplexed FM demodulated signal, MPX, having an L+R component at baseband, an L−R component sitting at 38 KHz, a pilot signal component at 19 kHz and possibly an RDS signal at 57 kHz.

The MPX signal may be represented as:

MPX=(L+R)+A×cos (2π×19×10³×t)+γ)+(L−R)×cos (2π×38×10³×t+η)

where A is an amplitude of the pilot tone signal.

Low pass filter 304 functions to filter all components above 15 KHz and therefore provides the L+R component of the MPX signal. The sampling rate is then reduced by a factor of five by decimator 306 to a rate of 48K samples per second. The lower the sampling rate, the more cost effective the remaining processing circuitry may be made. Multiplier 308 functions to mix the MPX signal with a locally generated signal having a value of 2 cos (2π×38000t) from a Cosine table not shown.

The size of the Cosine table (i.e. the number of required Cosine values) is dependent upon the sampling rate. In a digital domain, the value 2 cos (2π×38000t) may be represented as 2 cos (2π×38000kT) where k is the number of sampling points and T is the period of the sampling cycle. In the illustrated system, the sampling cycle is equal to (1/240,000) second. With these frequencies, the locally generated cosine signal becomes cos [(19π/60)×k]. Therefore, only sixty points are required in the Cosine table to generate a 38 kHz local signal at the second input of multiplier 308. The output of multiplier 308 is the L−R signal shifted to baseband.

The output of multiplier 308 may be represented by:

MPX×2×Cos (2π×38000t)=(L−R) Cos (η)+additional high frequency components

Filter 310 is then used to remove all high frequency components above 15 kHz. Again, for cost reasons mainly, decimator 312 reduces the sampling rate to 48 k samples per second. The decimated signal is multiplied by a phase correction signal, Cosθ, that will be discussed below.

In a similar manner Multiplier 320 functions to mix the MPX signal with a locally generated signal having a value of 2 sin (2π×38000t) from a Sine table not shown. The size of the Sine table (i.e. the number of required Sine values) is dependent upon the sampling rate. In a digital domain, the value 2 sin (2π×38000t) may be represented as 2 sin (2π×38000kT) where k is the number of sampling points and T is the period of the sampling cycle. In the illustrated system, the sampling cycle is equal to (1/240,000) second. With these frequencies, the locally generated cosine signal becomes Sin[(19π/60)×k]. Therefore, only sixty points are required in the Sine table to generate a 38 kHz local signal at the second input of multiplier 320. The output of multiplier 320 is the L−R signal shifted to baseband.

The output of multiplier 320 is:

MPX×2×Sin (2π×38000t)=−(L−R) Sin (η)+additional high frequency components

Filter 322 is then used to remove all high frequency components above 15 kHz. Again, for cost reasons mainly, decimator 324 reduces the sampling rate to 48 k samples per second. The decimated signal is multiplied by a phase correction signal, Sinθ, that will be discussed below. Multipliers 308 and 320 therefore function as free-running 38 kHz quadrature mixers so that the stereo signal (L−R) is shifted to baseband while the phase information remains intact.

The FM demodulated signal is also connected to multiplier 370 and multiplied by 2 cos (2π×20000t). Multiplier 370 functions to mix the MPX signal with the locally generated value of 2 cos (2π×20000t) from the Cosine table not shown. The input sampling rate is 240,000 samples per second. As a result, in a digital domain, the value at the second input of multiplier 370 becomes 2 cos [(2π×20000t)×(k/240000)]. This value may be simplified to cos(πk/6). Therefore, a twelve-point cosine table may be used to completely describe the value of the second input to multiplier 370. The output of multiplier 370 is an intermediate signal that is a 1 kHz pilot signal plus additional undesired components. In other words, the pilot signal component in the intermediate signal is a lower frequency than the pilot signal component in the input signal. Due to the presence of the additional undesired components, filter 372 is then used to remove all high frequency components above 1 kHz. Again, for cost reasons mainly, decimator 374 reduces the sampling rate to 12 k samples per second. The output of decimator 374 is an intermediate signal having a phase value. Power estimation is applied to the output of decimator 374. If the estimate power is above a predetermined threshold, then an indication is provided that the stereo signal is present. The decimated signal is fed to phase lock loop 376 to estimate the phase angle about the (L−R) signal. Phase lock loop 376 determines an approximate phase of the pilot signal component of the input signal and generates at least one trigonometric function using the approximate phase of the pilot signal component of the intermediate signal. The Cosθ and Sinθ outputs are the phase corrections to correction the outputs of decimators 312 and 324. When phase lock loop 376 is exactly locked, the value of θ equals η.

Multiplier 330 receives the output of decimator 312 and the Cosθ phase correction signal and generates a product to be added to the negative product of the output of decimator 324 and Sinθ. The generated sum provided by adder 350 is a first data component and is a phase corrected (L−R) signal so that the (L−R) signal is phase aligned with a second data component, the (L+R) signal. The output of adder 350 may be represented as:

(L−R) cos η×cos θ+(L−R) sin η×sin θ=(L−R) cos (η−θ)

Therefore, when θ exactly equals η indicating a lock condition for phase lock loop 376, the output of multiplier 3650 is exactly (L−R).

Stereo blender 360 generally functions to receive both the (L+R) signal and the (L−R) signal. When the receive signal is strong and small noise exists, a left channel signal and a right channel signal are generated. When the receive signal is weak and much noise is present, stereo blender 360 filters the (L−R) signal to reduce the effects of the noise. Additionally, attenuation of the (L−R) signal occurs to further reduce the noise. In this manner, the bandwidth of the (L−R) signal is significantly reduced to assist in eliminating noise. Further, if there the noise level is significant, the bandwidth of the (L+R) signal is also reduced. This reduction is known as “high cut”. Further if the signal is poor, the signal is generally muted to a certain extent. A further explanation of one implementation of a stereo blender for stereo blender 360 will now be given.

Illustrated in FIG. 4 is one form of stereo blender 360 of FIG. 3. A low pass filter 410 has a first input for receiving the L+R signal. An FM blender control circuit 420 has a first input for receiving multiple inputs from control circuitry 112 of FIG. 1. A first output of FM blender control circuit 420 is connected to a second input of low pass filter 410. An output of low pass filter 410 produces a filtered (L+R) signal. A low pass filter 430 has a first input for receiving the L−R signal. A second output of FM blender control circuit 420 is connected to a second input of low pass filter 430. An output of low pass filter 430 is a filtered (L−R) signal. A multiplier 415 has a first input connected to the output of low pass filter 410, a second input for receiving a gain signal, Gain 1, and an output. An adder 440 has a first positive input connected to the output of multiplier 415, and a second positive input connected to the output of low pass filter 430. An output of adder 440 provides the Left stereo output signal, L-Out. A multiplier 435 has a first input connected to an output of low pass filter 430, a second input for receiving a gain factor, Gain 2, and an output. An adder 450 has a negative input connected to the output of multiplier 435, and has a positive input connected to the output of multiplier 415. An output of adder 450 provides the Right stereo output signal, R-Out.

In operation, stereo blender 360 receives the (L+R) and (L−R) signals and uses the phase aligned (L−R) signal to generate a first output signal, R-out. Low pass filters 410 and 430 each has a dynamic bandwidth that varies depending upon the received signal condition. If the received signal is strong but there are multipath echoes that create distortion, the bandwidth is made narrower. Also, when there is adjacent signal interference and distortion occurs, the bandwidth is narrowed. In one form, the bandwidth of low pass filter 410 varies from approximately 3 kHz to around 15 kHz.

When a bandwidth adjustment of the low pass filters is needed, the low pass filter 430 initially reduces its bandwidth. Filter 430 is the first filter to change bandwidth because the (L−R) signal has been shifted from high frequency and is more easily corrupted than the (L+R) signal. It should be noted that a variety of known filters may be used to implement low pass filters 410 and 430. In one form, a conventional Finite Impulse Response (FIR) filter may be used to implement each of low pass filters 410 and 430. In another form, the FIR filters may be implemented in software with a user providing customized software modifiable filter coefficients. Using an FIR filter, as opposed to some other filters, may be advantageous to maintain the proper phase relationship between the (L+R) signal and the (L−R) signal. After the bandwidth of filter 430 has been reduced to a minimum bandwidth, the gain factor, Gain 2, may be reduced below one and the signal attenuated by multiplier 435. Once the Gain 2 factor has been tuned to a minimal factor, then the low pass filter 410 may be tuned to a lower bandwidth. Similarly, in addition to bandwidth reduction, the multiplier 415 may be used to attenuate the (L+R) signal to further remove noise. The modification of bandwidth and attenuation factors is accomplished by the FM blender control circuit 420 and signals from control circuitry 112. Adder 440 sums the (L+R) and (L−R) signals to produce a (2L) output signal as L-Out. Adder 450 sums the (L+R) signal with a negative of the (L−R) to produce a (2R) output signal.

Predetermined coefficients are used by low pass filters 410 and 430 to implement different bandwidths. Whether low pass filters 410 and 430 are implemented by software or with hardware circuits, the coefficients can be save in tables or can be calculated in real time.

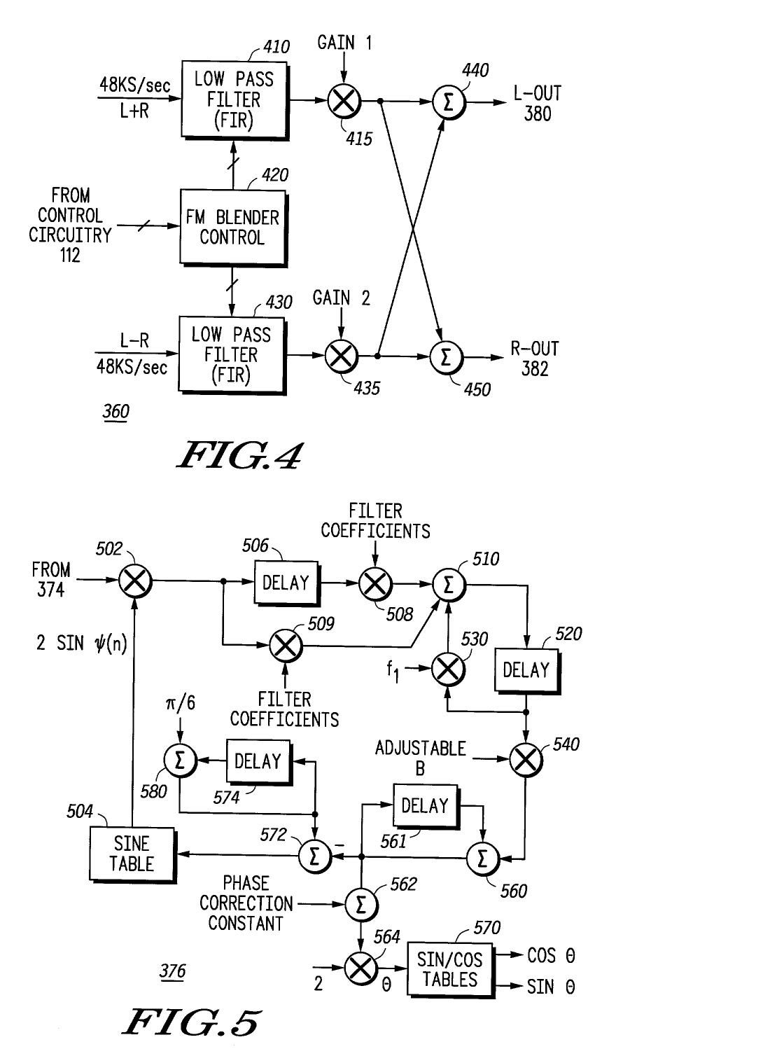

Illustrated in FIG. 5 is one form of many types of phase lock loops that may be used for phase lock loop 376 of FIG. 3. A multiplier 502 has a first input connected to the output of decimator 374 and has a second input for receiving a signal having a value of 2SinΨ(n). A Sine table 504 is connected to the second input of multiplier 502 for providing the value 2SinΨ(n) and functions as feedback in the phase lock loop 376. An output of multiplier 502 is connected to an input of a delay circuit 506. An output of delay circuit 506 is connected to a first input of a multiplier 508. A second input of multiplier 508 receives predetermined filter coefficients. An output of multiplier 508 is connected to a first input of an adder 510. The output of multiplier 502 is also connected to a first input of a multiplier 509. A second input of multiplier 509 also receives the predetermined filter coefficients. An output of multiplier 509 is connected to a second input of an adder 510. An output of adder 510 is connected to an input of a delay circuit 520. An output of delay circuit 520 is connected to a first input of a multiplier 530 and to a first input of a multiplier 540. A second input of multiplier 530 is connected to a frequency labeled F1. An output of multiplier 530 is connected to a third input of adder 510. A second input of multiplier 540 is connected to a signal labeled “Adjustable β” that represents an adjustable gain signal. An output of multiplier 540 is connected to a first input of an adder 560. An output of adder 560 is connected to an input of a delay circuit 561. An output of delay circuit 561 is connected to a second input of adder 560. The output of adder 560 is connected to a first input of an adder 562. A second input of adder 562 receives a signal that is a Phase Correction Constant or a predetermined phase correction. An output of adder 562 provides a resultant phase value and is connected to a first input of an adder 564. A second input of multiplier 564 receives a predetermined positive integer in the form of a constant value equal to “two”. An output of multiplier 564 provides a multiplied resultant phase value or phase angle, θ. The output of multiplier 564 is connected to an input of Sin/Cos Tables 570. Sin/Cos Tables 570 provides both cosine values, Cos θ, at a cosine output, and sine value, Sin θ, at a sine output. Sin/Cos Tables 570 determine at least one trigonometric function of the multiplied resultant phase value. An adder 572 has a first input connected to the output of adder 560. A second input of adder 572 is connected to an input of a delay circuit 574 and to an output of adder 580. A first input of adder 580 receives a value equal to (π/6), and a second input of adder 580 is connected to an output of delay circuit 574. An output of adder 572 is connected to an input of the Sine Table 504.

In operation, a decimated version of the output of low pass filter 372 is multiplied by multiplier 502 with a locally generated 1 kHz carrier signal. The multiplier 502 is performing a phase detection function. Multipliers 508, 509, 530 and 540, delay circuits 506, 520 and adder 508 collectively form a loop filter of a phase lock loop. The output of multiplier 540 is low pass filtered. Delay circuit 561 and adder 560 perform an accumulator function to accumulate phase error associated with the filtered signal at the output of multiplier 540. The output of adder 560 is an estimated phase signal of the signal received by the phase lock loop. Adder 580 and delay circuit 574 function to provide a free running phase accumulator signal that functions to generate a phase change due to the 1 kHz frequency of the local signal provided by Sine table 504. Adder 572 functions to combine the free running phase accumulator signal and the estimated phase signal to provide a total phase signal to Sine table 504. The phase angle is used to locate the sin value of the total phase angle.

In addition, the output of adder 560 is an accumulated phase signal that has some phase delay associated therewith due to coupling the signal through the low pass filter and the decimator prior to being received by the phase lock loop. The accumulated phase signal is added with a phase correction constant. The phase correction constant is a predetermined constant value that is obtained from a calculation of the phase frequency response of low pass filter 372 at 1 kHz. In other words, the constant is a value for compensating phase error resulting from the time delay that arises in coupling the pilot signal from the input of multiplier 370 to the input of the phase lock loop 374. Multiplier 564 multiplies the corrected phase by a factor of two. The factor of two is used in this particular example because the carrier of the (L−R) signal is 38 kHz while the pilot signal frequency is 19 kHz. The output of multiplier 564 is the phase angle needed to correct the phase error associated with the (L−R) signal. That phase angle is then used to locate the Sine and Cosine values for the phase angle in Sin/Cos tables 570.

By now it should be appreciated that there has been provided an all-digital decoder for use in an FM stereo receiver and a method of operation thereof. A cost-effective method is provided to decode and blend a stereo signal in an FM multiplexed signal in Digitized Intermediate Frequency (DIF) FM receivers. The present invention is particularly advantageous for the stereo production of a received weak FM signal. By using extremely fine filtering in a stereo blender and first filtering the (L−R) signal in the stereo blender, the effects of noise are significantly reduced without impacting the main signal channel, (L+R). Therefore, the fidelity of the signal is preserved without being negatively attenuated or filtered while the effects of noise are significantly removed. The (L−R) signal was frequency shifted from high frequency to bandwidth whereas the (L+R) signal was not. Therefore, the effects of noise in the main (L+R) signal channel is less severe.

The phase lock loop permits phase estimation and correction in a very cost effective manner. By first mixing a 19 kHz pilot signal with a special predetermined frequency to obtain a 1 kHz signal, further decimation of the signal to a very low sampling rate is achieved. The mixing is accomplished in a manner that permits a relatively small look-up table to be required. In particular, the size of the table is determined by the input sampling rate and the frequency of the signal to be mixed with the pilot signal. A 20 kHz signal is chosen because at 240K samples per second, only twelve points are required for the signal waveform to implement a Cosine table. As a result of the reduced sampling rate of the pilot signal, phase lock loop 376 may be operated at a very low sampling rate.

The present invention permits implementation of a software defined radio that can be readily programmed and modified. It should be well understood that all of the functions described herein may be implemented in software and code developed to implement all of the functions. The fact that software can be readily changed permits great flexibility to change audio quality and selectivity features dynamically. Frequency response characteristics may be modified and amplification can be changed based upon needs of a target application.

When circuits are used to implement the present invention, the use of an all-digital FM decoder is preferred over the use of analog components. Aging of analog circuitry is much more prone to failures. Temperature changes negatively affect the operating characteristics of all analog components.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

In the foregoing specification, the invention has been described with reference to specific embodiments. However, one of ordinary skill in the art appreciates that various modifications and changes can be made without departing from the scope of the present invention as set forth in the claims below. For example, the present invention may be implemented with various mixing circuits other than a multiplier. Additionally, multiplying can be performed by a shifting function and with shift operations. Various software techniques and hardware circuitry may be used to accomplish a sum, combine or add function. The filter coefficients may be software modifiable. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A decoder, having an input signal and a first output signal, comprising:
a multiplier for multiplying a predetermined value by the input signal to generate an intermediate signal, wherein the input signal has a pilot signal component and wherein the pilot signal component in the intermediate signal is a lower frequency than the pilot signal component in the input signal;
a filter for receiving the intermediate signal and for providing the pilot signal component as an output;
a phase lock loop for receiving the pilot signal component from the output of said filter, said phase lock loop determining an approximate phase of the pilot signal component of the input signal and generating at least one trigonometric function using the approximate phase of the pilot signal component of the intermediate signal;
means for using the at least one trigonometric function to phase align a first data component of the input signal and a second data component of the input signal and provide a phase aligned first data component; and
means for using the phase aligned first data component to generate the first output signal.

2. A decoder as in claim 1, wherein the at least one trigonometric function includes a sine function and a cosine function.

3. A decoder as in claim 1, wherein the predetermined value is retrieved from a table.

4. A decoder as in claim 3, wherein the predetermined value is a cosine value.

5. A decoder as in claim 1, wherein said decoder has a second output signal.

6. A decoder as in claim 5, wherein the first output signal is a right stereo channel and the second output signal is a left stereo channel, wherein the first data component is a difference between a left channel and a right channel, and wherein the second data component is a summation of the left channel and the right channel.

7. A decoder as in claim 1, wherein the means for using the phase aligned first data component to generate the first output signal comprises a stereo blender.

8. A decoder as in claim 7, wherein said stereo blender comprises:
a first filter for providing a first filter output;
a second filter for providing a second filter output; and
combining circuitry, coupled to said first filter and said second filter, said combining circuitry combining the first filter output and the second filter output to produce the first and second output signals.

9. A decoder as in claim 8, wherein filter coefficients of said first filter are selectable, and filter coefficients of said second filter are selectable.

10. A decoder as in claim 8, wherein said first filter and said second filter are FIR filters.

11. A decoder as in claim 1, wherein the decoder is used in a radio receiver.

12. A decoder as in claim 1, wherein the predetermined value is approximate to, but not equal to, a frequency of the pilot signal component in the input signal.

13. A decoder as in claim 12, wherein the predetermined value is within 3 kilohertz of the frequency of the pilot signal component in the input signal.

14. A decoder as in claim 1, further comprising:
a decimator, coupled between said filter and said phase lock loop.

15. A decoder as in claim 14, wherein said decimator reduces a frequency of the intermediate signal.

16. A decoder as in claim 15, wherein said decimator reduces the frequency of the intermediate signal by a factor of 20.

17. A decoder as in claim 1, wherein said phase lock loop operates at a frequency less than one tenth a frequency of the input signal.

18. A method for decoding an input signal using only digital circuitry, comprising:
receiving the input signal;
using a phase lock loop having feedback to estimate phase information of at least one component of the input signal using only digital circuitry, the phase lock loop receiving an intermediate signal having a phase value; and
completing decoding of the input signal to generated an output signal.

19. A method as in claim 18, wherein the step of using the phase lock loop further comprises:
adding a predetermined phase correction to the phase value to produce a resultant phase value, wherein the predetermined phase correction is a function of a delay of a portion of the digital circuitry.

20. A method as in claim 18, wherein the step of using the phase lock loop further comprises:
multiplying the resultant phase value by a predetermined positive integer to produce a multiplied resultant phase value; and
determining at least one trigonometric function of the multiplied resultant phase value.

21. A method for decoding an input signal containing information on a left channel L and a right channel R, the method comprising:
filtering a L+R signal to produce a filtered L+R signal, where L is the left channel and R is the right channel;
filtering a L−R signal to produce a filtered L−R signal; and
after filtering the L+R signal and the L−R signal, combining the filtered L+R signal and the filtered L−R signal to produce a left channel output signal and a right channel output signal.

22. A method as in claim 21, wherein said step of filtering the L+R signal and said step of filtering the L−R signal are performed using at least one FIR filter.

23. A method as in claim 21, wherein said step of filtering the L+R signal and said step of filtering the L−R signal are performed in software.

24. A method as in claim 23, further comprising:
providing software modifiable filter coefficients.
